(19) United States
(12) Patent Application Publication
(10) Pub. No.: US 2019/0212142 A1
(43) Pub. Date: Jul. 11, 2019

(54) SYSTEM AND METHOD FOR USING DIGITAL TECHNOLOGY TO PERFORM STEREO AERIAL PHOTO INTERPRETATION

(71) Applicant: Glen C. Gustafson, Avalon, CA (US)

(72) Inventor: Glen C. Gustafson, Avalon, CA (US)

(21) Appl. No.: 16/242,638

(22) Filed: Jan. 8, 2019

Related U.S. Application Data
(60) Provisional application No. 62/614,630, filed on Jan. 8, 2018.

(51) Int. Cl. G01C 11/20; H04N 5/262; H04N 13/167; G02B 27/22; H04N 13/30; G03B 35/02; G03B 35/18

(52) U.S. Cl. CPC G01C 11/20; H04N 5/2628; H04N 13/167; H04N 2213/001; H04N 13/30; G03B 35/02; G03B 35/18; G02B 27/2228

(57) ABSTRACT

A system for performing stereoscopic views of digital photographs using a high resolution, retina display monitor, one or more lens stereoscopes positioned over a plurality of computer loaded images that has been pre-positioned and properly zoomed in for comparative purposes. A method for using the aforementioned system to perform 3D aerial photograph interpretations on digital only, rather than analog, images sent to said system and properly aligned/positioned on a high resolution monitor using one or more positioned lens stereoscopes.

### CROSS REFERENCE TO RELATED APPLICATION

This application is a perfection of U.S. Provisional Application Ser. No. 62/614,630, filed on Jan. 8, 2018, the disclosure of which is fully incorporated by reference herein.

### BACKGROUND OF THE INVENTION

### 1. Field of the Invention

This invention relates to the field of aerial photograph interpretation, particularly stereo interpretation. More particularly, as there are fewer and fewer analog photographs available to use for such comparisons, this invention enables the use of one or more digital photographs for side-by-side 3D comparisons.

### 2. Relevant Art

There are numerous references that may be pertinent to this disclosure including but not limited to U.S. Pat. Nos. 3,678,190, 5,259,037, 5,381,338, 5,493,677, 5,517,419, 6,459,425, 7,509,241, 7,519,200, 7,783,135, 7,809,722 and 8,149,268, along with Published U.S. Application Nos. 20080111815, 20110019112, 20110216962, 20120120069 and 20130060540. There are also pertinent disclosures in the following YouTube videos. See: https://www.youtube.com/watch?v=mZkmXEFw7BE, https://www.youtube.com/watch?v=XgyH7CdPiMo, and https://www.youtube.com/watch?v=bLYNtAcu8Ik.

Most of the aforementioned patents pertain to photogrammetry work in the mapping and engineering fields. There are two separate professions here. “Photogrammetry” generally refers to the mathematical methods of obtaining accurate measurements and maps from aerial imagery. “Photo Interpretation”, on the other hand, may involve some simple measuring, but it is primarily the science of looking at aerial images, recognizing objects, and deducing their significance. To a typical Photo Interpreter (PI) such as this inventor, the computer will always be a helper and never a threat because it cannot deduce the significance of the image content!

The entertainment industry including the Augmented Reality and Virtual Reality (VR) sectors thereof would be the users of this technology of high quality stereo observation of a computer screen. It could also be used in video gaming, medical imaging, drone photography observation, architecture, perhaps even in three dimensional astronomy analyses, i.e., anything where 3D visualization of an object or property is needed. Yet another application would be the viewing of homes and properties in the real estate field.

Those in this field (including photogrammetry) are very traditional and tend to be “purists”, always wanting the very highest resolution possible. This is traditionally thought to be available only from hardcopy FILM reproductions (called “diapositives”). The possibilities of such resolution using a computer monitor have not typically been appreciated. This is largely possible, however, because one first does the ZOOMING digitally, before looking at one or more hugely enlarged ground features on the screen . . . in 3D! If the airphotos were scanned appropriately, the quality of this view of the terrain, although slightly inferior, is very useable.

Photogrammetry U.S. Pat. No. 8,149,268 is noteworthy. It is for automatically determining the dimensions of an object, based on various kinds of monoscopic input images. It is a photographic MEASURING technique whereas the present invention is not primarily concerned with measuring or calculating anything.

This method of stereo observation of digital photography (could be aerial or ground photography) is straightforward. Yet, it solves a basic, modern viewing problem for anybody who wants to look at digital imagery . . . in stereo. Using the right pieces of commercial hardware and software, and developing a procedure that is quickly and easily do-able by anyone with these pieces of gear, it is transferable immediately to anybody else in the field. It took months of experimentation to master but would be well suited for those who now provide monoscopic, historical aerial photography of industrial and commercial sites such as the company, Environmental Data Resources, Inc.

Admittedly, one alternative to this is the use of a complex and expensive photogrammetry system, one that is usually packaged within a Geographical Information System (GIS). The inventor has used such systems . . . and other photogrammetry tools. In that methodology, however, just to view images requires an extensive set-up involving ground control points, inner orientation, outer orientation, etc. Once all of that is done, the images can be observed, and very accurately measured, mapped, and overlaid on topographic maps. But that is all a wasted effort, making the job more expensive and time consuming, if all that is needed is a user-friendly method for VIEWING digital images stereoscopically.

The use of digital technologies in the field of Aerial Photo Interpretation (API) has been ubiquitous for at least 25 years. At the core of this effort has been the Raster GIS or Geographical Information System (e.g., ERDAS Imagine). This has been supplemented by standard Digital Image Processing (DIP) programs like Adobe PhotoShop everywhere around the world.

One of the common civilian applications of these technologies has been historical studies from old aerial photography. For example, the histories of polluted industrial sites are studied intensively, every day, in all corners of the globe. The API efforts cannot answer all questions about the contamination of soil, water, or air, but they can answer some questions quite confidently. This is especially important if the cases are, or might come, under litigation.

Several companies have come to serve this market of conducting the archive research and obtaining the historical aerial photos needed for work of this kind. Typically, they create a report consisting of a series of enlargements for a particular target area over many points in time. This has the benefit of very rapidly producing an overall view of an industry between those points in time. While aerial photography can often be delivered digitally within 48 hours or less, current practices have two important drawbacks. First, the scan quality of these digital reports is not usually adequate for zooming into small details. Second, and equally important, there is no consideration for STEREO in this process. The photographs are useful to illustrate the general development of a site (e.g., the appearance of new buildings, outdoor equipment, storage tanks and waste ponds, etc.). However, these monoscopic, low resolution aerials are all but useless for detailed analysis.

The use of stereo is a huge benefit in this analysis work. First, it provides a three-dimensional view of a given area of concern. In addition, because of the way in which the human brain combines the two photos, if one photo is substandard or out of focus, the brain tends to emphasize the better photo thus providing a three-dimensional view which is truly optimized for a better human understanding thereof.

Various historical research efforts are being disrupted by a shift in the industry. Photo labs are going away, almost fully gone. The impact of this on a Photo Interpreter is that he/she can no longer easily obtain duplicate film reproductions, or “diapositives”, which are the highest quality view of a former terrain that can be produced. These diapositive films are placed under a Zoom Stereoscope (see FIG. 1), where they can be comfortably viewed and magnified many times. The point of this approach is that it allows a stereoscopic visual re-creation of the former landscape in which tiny details can be confidently interpreted and reported on.

### BRIEF SUMMARY OF THE FIGURES

Further features, objectives and advantages of this invention will be made clearer with the following Detailed Description made with reference to the accompanying drawings in which:

FIG. 1 is a side-by-side, split perspective view showing on the left side, a close up of a typical Bausch & Lomb Zoom Stereoscope ZS over a photograph P, the right side of this perspective view adding a laptop L (Note that this known, prior art system was only used for making monoscopic comparisons and producing report illustrations.);

FIG. 2 is a diagram showing some terminology and relative geometric relationships for a stereoscopic model viewing an overlap O between two photographs 1 and 2, taken in the same aerial direction (arrow A) said view being what an observer creates mentally;

FIG. 3A is a diagram showing an eye base, or interpullary distance IPD between the separation S of photographs P1, P2 when stereoscopic viewing using a lens stereoscope LS;

FIG. 3B is a diagram showing an interpullary distance IPD for an effective eye base EEB using a mirror stereoscope MS (that has an adjustable viewing width) to view a pair of photographs P1, P2 that are distinctly kept apart by a known separation S;

FIG. 4 is a diagram showing an idealized flight plan (mapping) with numerous vertical photographs (numbered 1 through 11) taken with 60% overlap along flight path lines and a 25-30% sidelap between adjacent flight lines (such overlaps providing the opportunity for several different, high quality stereo views);

FIG. 5 is a top perspective view showing one embodiment of the system of this invention used for stereoscopically viewing on a retina screen display RSD with separate, spaced apart lens stereoscopes LS1 and LS2 to inspect and analyze for comparison purposes of aerial photographs Y1L, Y1R (for year 1971) and Y2L, Y2R (for 1977) of the same industrial site IS;

FIG. 6 is a top plan view of the system from FIG. 5 showing the layout of the same four photographs Y1L, Y1R, Y2L and Y2R on the retina screen display RSD with the two separate lens stereoscopes LS1 and LS2 positioned thereon for making comparisons per this invention;

FIG. 7 is a bottom perspective view showing one means for supporting the external flat RSD monitor using corner legs CL1, CL2, CL3 and CL4 for comfortable viewing on a work table (not shown), perhaps over many hours (Note: because cables (also not shown) connect to the back of monitor RSD, through cable connect portals CCP1, CCP2 and power outlet PO, the monitor cannot simply be laid flat on a viewing/work table);

FIG. 8 is a perspective view showing a desktop arrangement per one system of this invention (left side), comprising a pair of spaced lens stereoscopes LS1 and LS2 atop a photograph P1 displayed on a monitor RSD, the whole of that system sitting adjacent a prior art-analog viewing system with its own Zoom Stereoscope ZS for viewing a diapositive film stereogram P2, said desktop further including a report-writing laptop L to the far right (Such a side-by-side, dual setup is needed because only a few years of aerial photography for a given site will be available as film reproductions, while the remainder (i.e., majority) will be available as digital scans); and

FIG. 9 is a top plan view showing a monitor RSD set for displaying and then stereoscopically examining, through two separate lens stereoscopes LS1, LS2 four different year pairs (left and right) Y1, Y2, Y3 and Y4 of aerial photographs for the same site per the present invention.

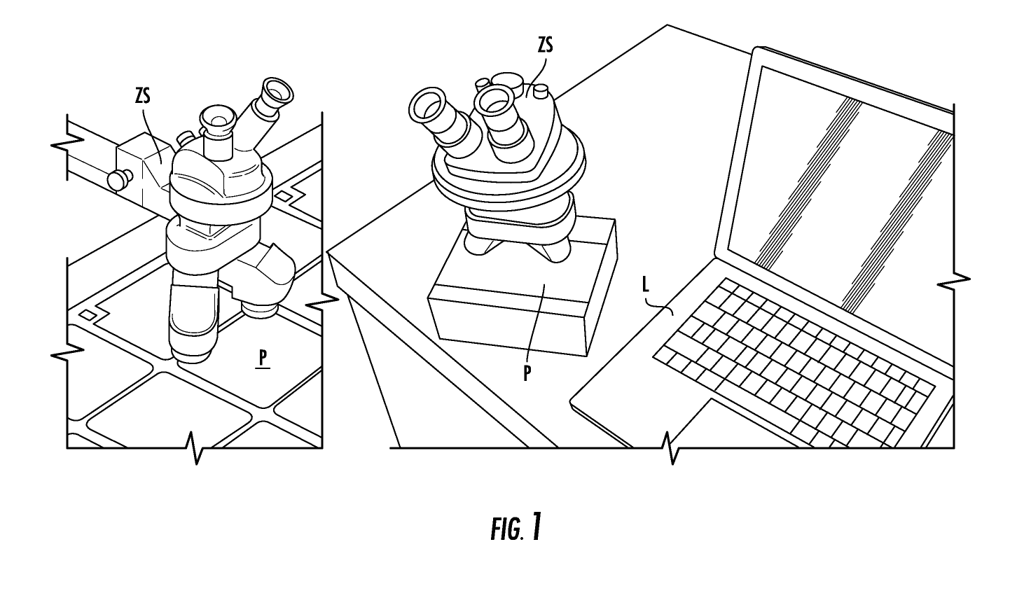

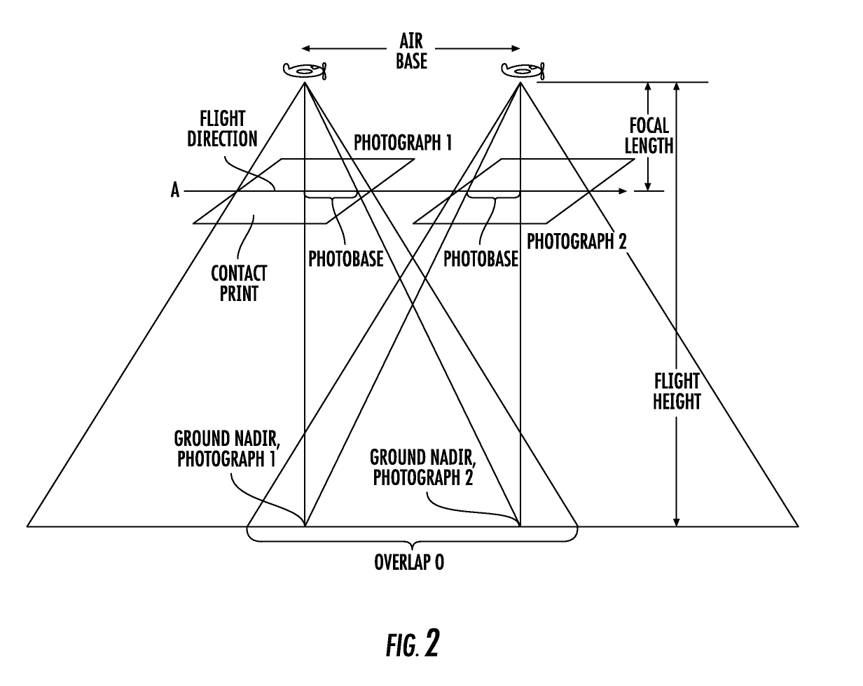

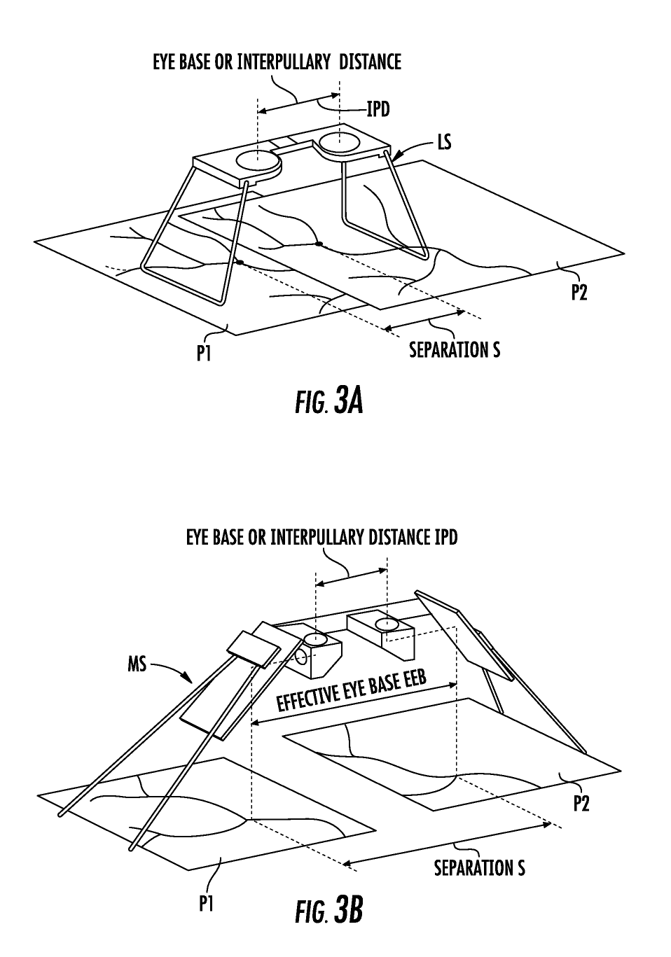

### SUMMARY OF THE INVENTION

This invention pertains to a system for performing stereoscopic views of digital photographs using a high resolution, retina display monitor, one or more lens stereoscopes positioned thereover and a computer loaded image that has been pre-positioned and properly zoomed in for comparative purposes. The invention further discloses a method for using the aforementioned system to perform 3D aerial photograph interpretations on DIGITAL, rather than just mere analog, images sent to said system and properly aligned/positioned thereon.

### DETAILED DESCRIPTION OF PREFERRED EMBODIMENTS

Until the present invention, it has not been possible to easily observe, in stereo, from scanned historical aerial photographs digitally displayed on a computer screen without quite expensive hardware and software systems. Even if this capability was on hand, a GIS (Geographical Information System) setup effort greatly increases the cost of such an endeavor. As such, it has not been possible for environmental investigators to quickly, yet easily observe stereo aerial photographs that are only available in digital form.

Admittedly, the computer and digital entertainment industries have been moving forward at a rapid pace. For example, the computer gaming arena has constantly sought more realistic and detailed presentation of the virtual “battlefield”. Similarly, large-screen television sets and computer monitors have required more and more pixels to present an attractive, sharp picture. New computer displays have appeared under various names such as Retina Display, ultra-high definition TV, 4K monitor, 5K monitor, etc.

The application of this technology to historical API began with experiments using inexpensive, smartphone stereoscopes such as the Speck stereoscope and the Google “Cardboard”. The input digital files and native resolution of a phone does not permit a satisfying viewing experience, however.

The appearance of “Retina Display Monitors” for laptop computers changed all of this! Although first perceived as an advertising and marketing ploy, it has had a very real impact on visual display interpreting. The average laptop computer has a screen with perhaps 1200 to 1800 pixels across its screen from left to right. The new Retina Display screens boasts 2850 pixels across its screen. Early experiments on a laptop screen showed that scanned aerial photos could be very adequately viewed, in stereo, on such equipment. However, it was awkward and uncomfortable because of the ergonomics of trying to position a stereoscope over one's laptop screen. In addition, a laptop computer might not allow itself to be laid completely flat on the viewing area/table.

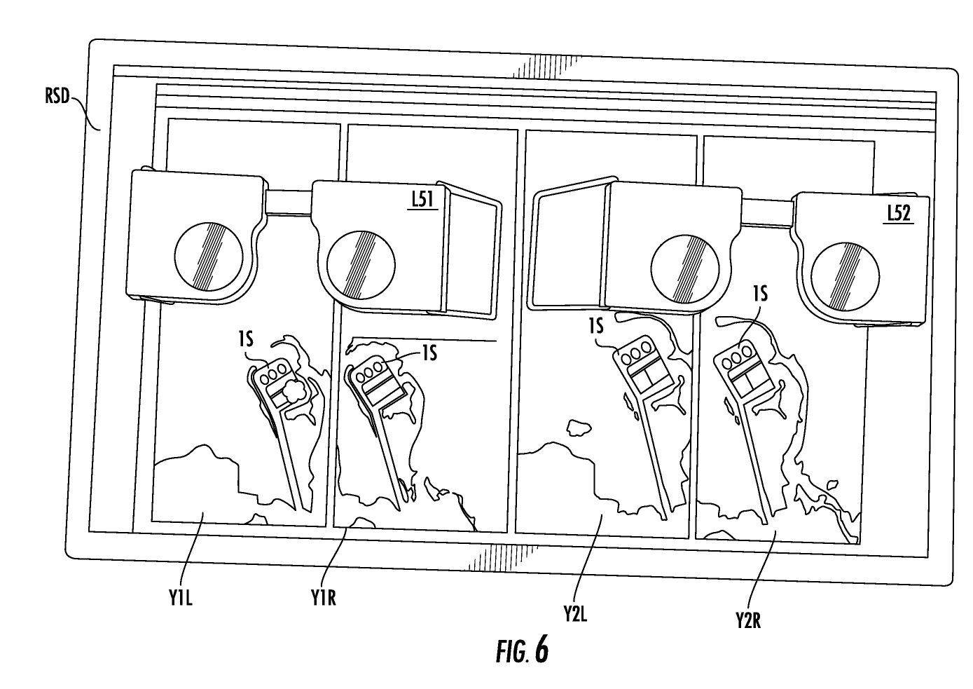

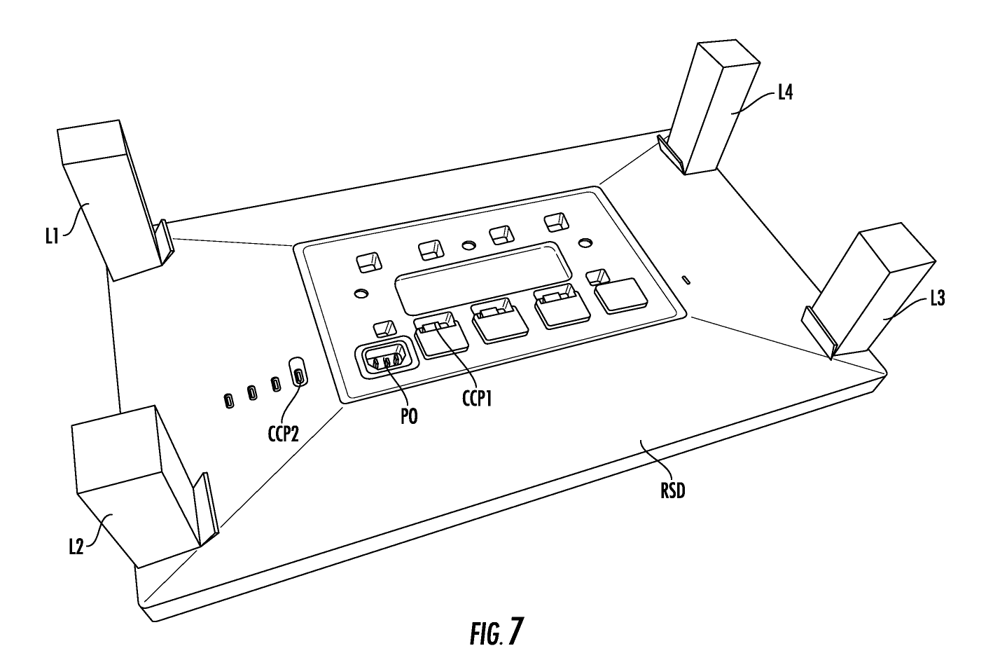

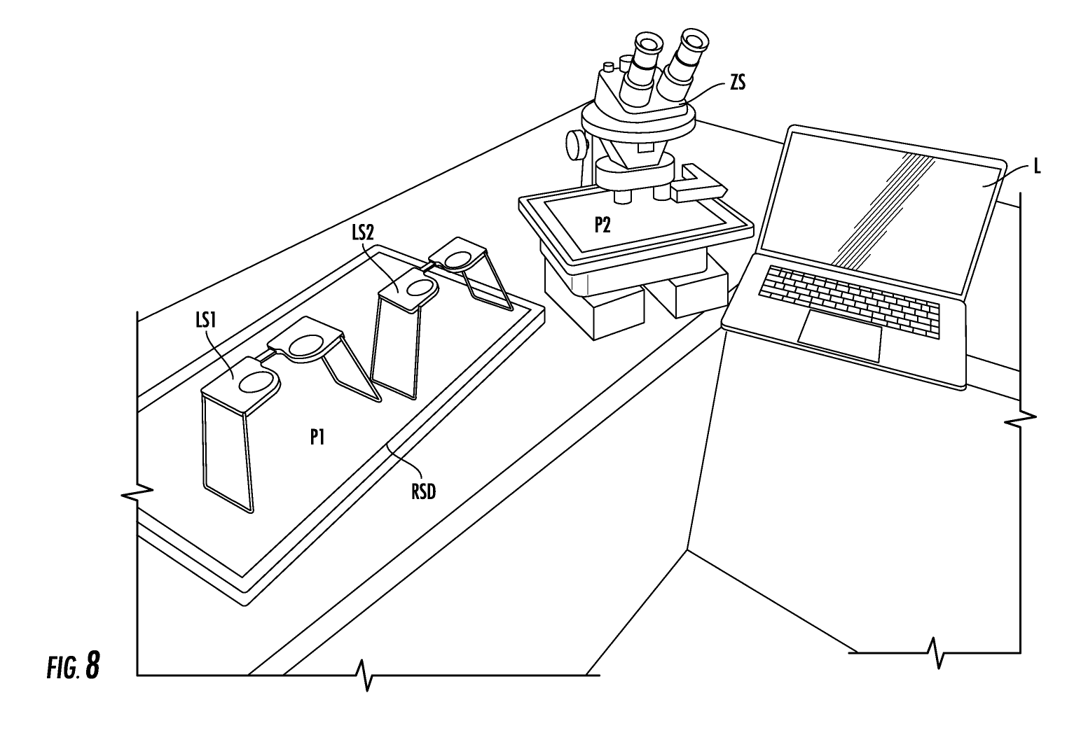

Per the present invention, using an external monitor hooked up to the laptop solves the foregoing problems. Thus, the image processing software and report writing software would operate on the laptop monitor, while the display of the one or more stereo aerial photos would occur exclusively on a 21-inch Retina Display 4K Monitor sitting flat on the desk with a lens stereoscope sitting directly thereover. FIG. 6 shows this configuration in use for comparing two different years of aerial coverage for a given site.

The mechanics of making all that come together comfortably, took some experimentation. However, it did succeed. Several, months-long environmental investigations have been completed, almost exclusively, based on these techniques. And an operating procedure has now been defined.

### Operating Procedure

1. Obtain the highest quality, highest resolution scan images of the aerial photographs for the time periods needed.
Scan resolution should be at least 12 microns, but much better: 7 microns.
Scans should be done from the original negatives, where possible.
Stereo pairs (or triplets) should be ordered; also redundant coverage from adjoining flight lines can prove quite beneficial.

2. Pre-process the individual frames of photography.
Clip out the target area from each of the exposures carefully labeling each.
Use DIP techniques to enhance and match the target clips.
If they are from the same flight line, rotate each image 90 degrees and save this version of the photo. (Note: Shadows pointing downscreen are best, when possible.)

3. Using Adobe PhotoShop, pull up two of the corresponding stereo images on the external monitor.
Use the following menu procedure to position the photos correctly for stereo viewing:

### Window/Arrange/Tile all Views Vertically

Zoom and reposition the images until you see the left and right photos side-by-side.
   Position the two photos so that corresponding images are about 55 mm apart.

4. Place a lens stereoscope over the monitor and adjust until stereo viewing is comfortable.
If a reverse stereo is encountered, drag the photo on the left to the right side.
If little to no stereo is observed, change the rotation of the images by 90°.
Zoom and reposition the two photos, individually, as appropriate.

5. Begin interpreting the stereo-pair and writing the report on the laptop screen.

### Some Working Guidelines

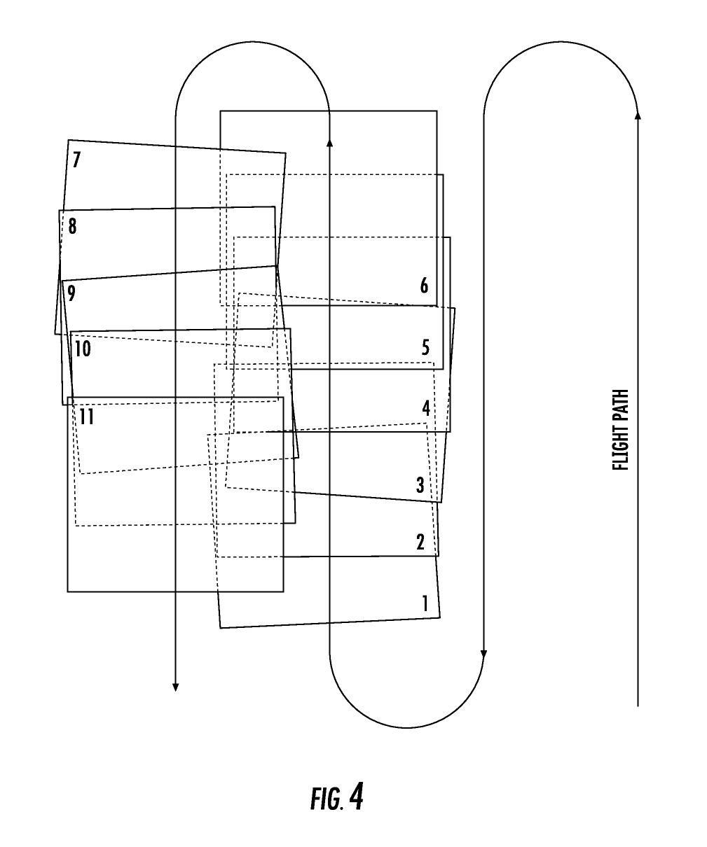

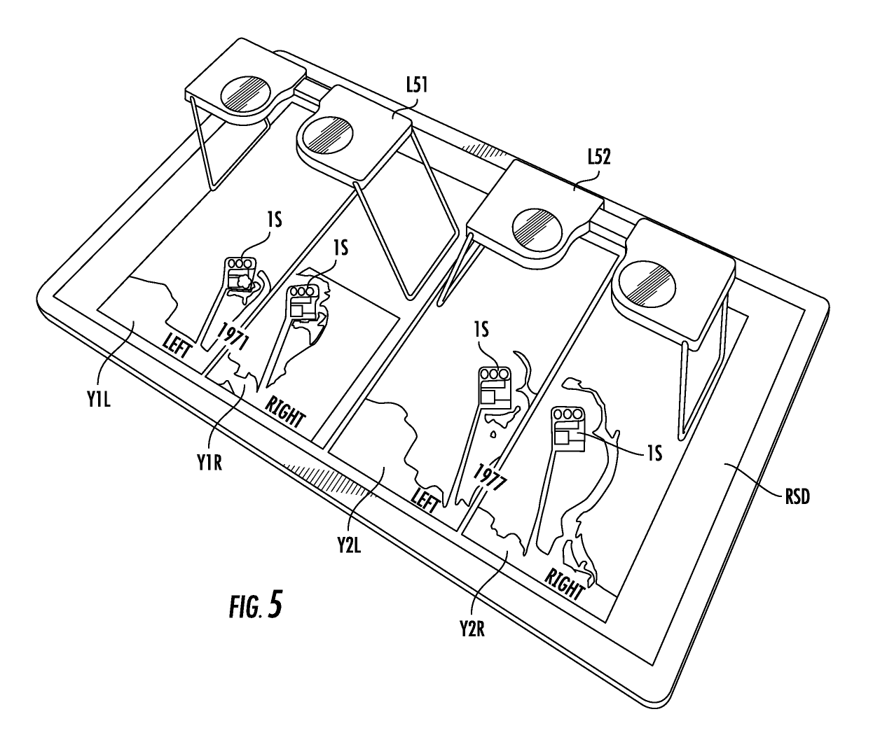

The success of any stereo photograph interpretation depends on having good quality images to begin with. The importance of scan resolution was stressed above, if small details are necessary to the investigation. If photos from adjoining flight lines are used (per FIG. 4), rotation of the images will not be necessary.

In general, a good operating procedure for photographic comparisons starts by cutting out the target area from a stereo-pair. Save those files with an “X” attached to the end of the filename. Then rotate each of the two images 90 degrees, and resave the files, with a “Y” attached to the filename. In this way, the Y-files can be used for standard observation along one flight line, and the X-files for observation across two flight lines. This is mentioned, because for a variety of stereo views, it is often very helpful to identify and then interpret small details, or very subtle features, like ground stains from pollutants.

Such methodology also permits very easy comparisons of different years of target coverage. The procedure would be to get the first year of coverage displayed as described above, then open two photos in the same way for another flight year. After doing this, use the procedure to WINDOW/ARRANGE/TILE ALL VIEWS VERTICALLY once more, then zoom and move about the two images until your two stereo-pairs are displayed side by side. Such comparisons are most easily made by positioning two separate stereoscopes over the same visual display monitor, before shifting between the two scopes, back and forth, from one to the other. In this same fashion, further comparison stereo-pairs can be opened at the same time, and very easily viewed.

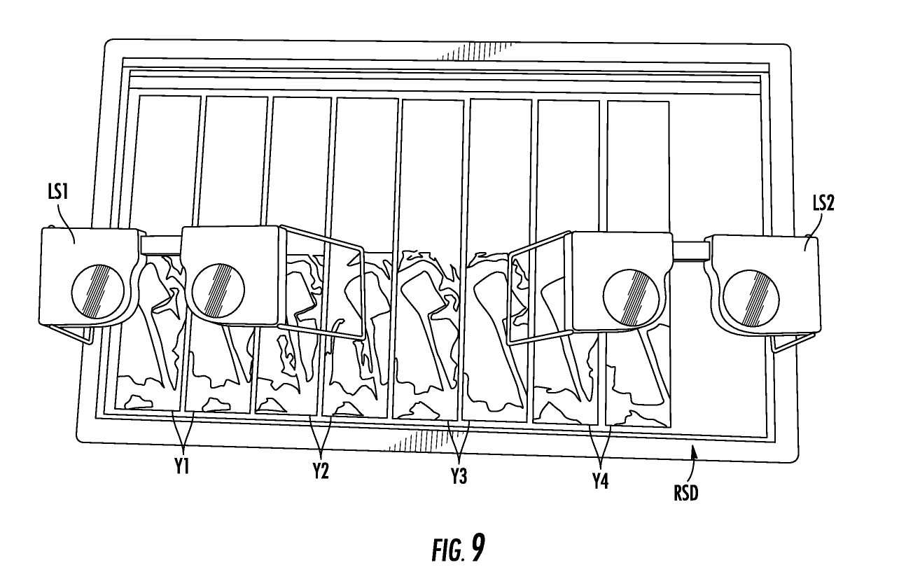

It is easily possible to compare stereo-pairs from four different photo flights (i.e., eight photographs) on the same screen. FIG. 9 illustrates this setup. This is an enormous advantage over traditional film viewing techniques, when trying to create a history for a polluted, industrial site, or any other features being studied through time.

In conclusion, this procedure allows the detailed interpretation of industrial scenes in good stereo from digital input materials. Although the level of zooming, and quality of stereo imagine may not be as good as film diapositives made from the original negatives, such diapositives are being less and less available for use in these types of side-by-side comparisons. Of course, some actual film reproductions are still available on a very limited basis. Hence, a well-equipped photo interpreter must be able to use either method, and compare images side-by-side, from different media types.

Having described the presently preferred embodiments, it is to be understood that this invention may also be embodied in the scope of the appended claims.

What is claimed is:

1. A system for performing 3D aerial photograph interpretations on digitally supplied images, said system comprising: (i) a retinal display monitor configured to stand flat on a raised platform with all power and computer connections readily fitting under said platform; (ii) means for delivering to the display monitor photographs of a target area in a scan resolution of at least about 7 microns; (iii) means for zooming in on said photographs and rotating said photographs to provide a split screen image of the target area on the display monitor; and (iv) one or more lens stereoscopes on separate stands, spaced apart from each other and resting directly on the display monitor to observe and perform 3d interpretations of the target area.

2. The system of claim 1 wherein all legs of the at least two lens stereoscopes are covered with tape or felt to prevent them from scratching the display monitor while using the at least two lens stereoscopes to perform 3d interpretations of the target area.

3. The system of claim 1, which delivers photographs to the display monitor in a scan resolution of at least about 12 microns.

4. The system of claim 1 wherein the display monitor has a plurality of leg supports at least temporarily attached to its rear surface.

5. The system of claim 4 wherein the plurality of leg supports are separately height adjustable.

6. The system of claim 1 wherein the photographs supplied to the display monitor are from original negatives.

7. The system of claim 1 wherein the photographs supplied to the display monitor are in at least stereo-pairs of the target area.

8. The system of claim 7 wherein the photographs supplied to the display monitor are in stereo triplets of the target area.

9. The system of claim 1 wherein the photographs supplied to the display monitor are arranged vertically side-by-side.

10. The system of claim 1 wherein the photographs supplied to the display monitor are taken aerially over the target area in an overlapping sequence.

11. The system of claim 1 wherein the zooming and rotating means includes using software such as Adobe Photoshop.

12. A method for performing 3D aerial interpretations of digital-only supplied aerial photographs of a target area at two or more different points in time for conducting a comparative analysis of differences in the target area over the two or more different points in time, said method comprising:
(a) providing a system consisting of: (i) a retinal display monitor configured to stand flat on a raised platform with all power and computer connections fitting under said platform; (ii) means for delivering to the retinal display monitor a plurality of digital photographs of the target area in a scan resolution of at least about 7 microns; (iii) means for zooming in on a common area in plurality of digital photographs of the target area and rotating said digital photographs to provide vertically viewable, split screen images of the common area on the retinal display monitor; and (iv) one or more lens stereoscopes for resting directly on the retinal display monitor without scratching or otherwise damaging the retinal display monitor;
(b) delivering to the retinal display monitor the plurality of digital photographs of the common area at two or more different points in time;
(c) zooming and rotating the plurality of digital photographs for examining side-by-side the common area on the retinal display monitor at two or more different points in time;
(d) providing one or more lens stereoscopes on one or more stands that can be manually spaced apart and positioned directly on the retinal display monitor; and
(e) performing at least one stereoscopic aerial interpretation looking through said at least two lens stereoscopes resting on the retinal display monitor for noteworthy visual differences in the common area at two or more different points in time.

13. The method of claim 12, which delivers photographs in a scan resolution of at least about 12 microns.

14. The method of claim 12 wherein the display monitor has a plurality of leg supports at least temporarily attached to its rear surface.

15. The method of claim 14 wherein the leg supports are separately height adjustable.

16. The method of claim 12 wherein the zooming and rotating means includes Adobe Photoshop software.
